(19) United States
(12) Patent Application Publication
(10) Pub. No.: US 2025/0196432 A1
(43) Pub. Date: Jun. 19, 2025

(54) METHOD AND SYSTEM FOR ALL-AQUEOUS PRINTING OF VISCOELASTIC DROPLETS

(71) Applicant: University of Virginia Patent Foundation, Charlottesville, VA (US)

(72) Inventors: Liheng Cai, Charlottesville, VA (US); Jinchang Zhu, Charlottesville, VA (US)

(21) Appl. No.: 18/866,986

(22) PCT Filed: May 19, 2023
(86) PCT No.: PCT/US2023/067234

§ 371 Date: Nov. 18, 2024

Related U.S. Application Data
(60) Provisional application No. 63/343,575, filed on May 19, 2022.

(51) Int. Cl. B29C 64/112; B29C 64/209; B29C 64/232; B29C 64/236; B29C 64/393; B33Y 10/00; B33Y 30/00; B33Y 50/02; B33Y 70/00

(52) U.S. Cl. CPC B29C 64/112; B29C 64/209; B29C 64/232; B29C 64/236; B29C 64/393; B33Y 10/00; B33Y 30/00; B33Y 50/02; B29K 2995/0056; B33Y 70/00

(57) ABSTRACT

This document describes printing viscoelastic material in an aqueous medium. Such printing can involve positioning a print nozzle at specified coordinates in the medium and triggering deposition of the viscoelastic material to form a viscoelastic droplet. The deposition can be established by delivering a specified flow velocity of the viscoelastic material through an aperture in the print nozzle. The print nozzle can be detached from the droplet and a receiving material by translating the nozzle relative to the droplet according to a specified acceleration. The droplet can remain captive on or within the receiving material upon detachment from the nozzle.

### CLAIM OF PRIORITY

This application claims priority to U.S. Provisional Application Ser. No. 63/343,575, filed on May 19, 2022, which is incorporated by reference herein in its entirety, and the benefit of priority of which is claimed herein.

### STATEMENT REGARDING FEDERALLY SPONSORED RESEARCH OR DEVELOPMENT

This invention was made with government support under Grant No. 1944625 awarded by the National Science Foundation. The government has certain rights in the invention.

### BACKGROUND

Additive manufacturing, also known as three-dimensional (3D) printing, can contribute to innovations in many areas, such as engineering, manufacturing, art, education, and medicine. One approach to 3D printing involves digital assembly of spherical particles (DASP). This technique facilitates placement of individual spherical particles at predetermined locations within a 3D space. Such particles can be held in place by a variety of methods, including adhesion, mechanical forces, and magnetic forces. A structure can be built up by adding more spherical particles to the predetermined locations. DASP can be used to form a variety of structures of specified shapes, sizes, and densities. These structures can be highly customizable such as to be used in a variety of applications, including medical diagnostics, drug delivery, and nanotechnology.

### SUMMARY

Three-dimensional (3D) printing can be performed using biocompatible materials, cells, and supporting components in order to form complex 3D functional living tissues. For example, 3D bioprinting can be applied to regenerative medicine to address the need for tissues and organs suitable for transplantation. Compared with certain non-biological printing approaches, 3D bioprinting involves additional complexities, such as the choice of materials, cell types, growth and differentiation factors, and technical challenges related to the sensitivities of living cells and the construction of tissues. 3D bioprinting can be used for the generation and transplantation of several tissues, including multilayered skin, bone, vascular grafts, tracheal splints, heart tissue, and cartilaginous structures. Other applications include developing high-throughput 3D-bioprinted tissue models for research, drug discovery, and toxicology.

A digital assembly of spherical particles (DASP) technique can be used for creating such 3D-bioprinted tissue models. One approach to bioprinting using DASP involves the formation of a droplet voxel by combining a hydrogel with a cell suspension, which can then be extruded from a print nozzle. This technique can enable formation of tissue models which can mimic the functional organization of mammalian tissues. The location, composition, and properties of individual voxels and voxel-voxel interactions can be manipulated, e.g., by controlling parameters of the print nozzle during extrusion, to help form the tissue model to precisely mimic certain complexities of target biological tissues.

This document describes a method for printing viscoelastic ink droplets in an aqueous medium. Such a method can include positioning a print nozzle at specified coordinates in the aqueous medium. In an example, deposition of viscoelastic material can be triggered to in order to extrude at least one viscoelastic droplet having a specified diameter. For example, the deposition can be extruded by delivering a specified flow velocity of a viscoelastic material through an aperture in the print nozzle. In an example, the print nozzle can be detached from the droplet and a receiving material by translating the print nozzle, relative to the droplet, according to a specified acceleration. For example, the specified acceleration can be within a range between 0.1 meters per second squared (m/s²) and 25 m/s². In an example, the droplet can remain captive on or within the receiving material located in the aqueous medium following the detachment from the print nozzle.

In an example, the specified coordinates can include first coordinates (e.g., cartesian coordinates such as x, y, & z) corresponding to a first pixel or a first voxel from an image defining a three-dimensional (3D) structure to be printed. In an example, positioning the print nozzle can include establishing or adjusting the position of the print nozzle to compensate for displacement of the at least one viscoelastic droplet away from the specified coordinates in relation to detaching the print nozzle from the droplet. For example, the method can include performing digital assembly of spherical particles (DASP) to establish the 3D structure including the at least one deposited viscoelastic droplet. In an example, the at least one viscoelastic droplet can include a biological material. In an example, performing DASP can include assembling a plurality of viscoelastic droplets to establish a biological material model. In an example, the biological material model can include mammalian cells.

In an example, positioning the print nozzle can include at least one of translating or rotating the print nozzle toward the specified coordinates. In an example, the receiving material can include a three-dimensional (3D) supporting matrix, e.g., a supporting bath made of yield stress fluid. Positioning the print nozzle can also include imaging the depositing of the at least one viscoelastic droplet onto the receiving material, and the imaging can be used as feedback in positioning the print nozzle.

In an example, the method can include establishing or adjusting the specified acceleration such as to regulate a roundness of the deposited at least one viscoelastic droplet to length/width ratio within a range from 1:1 to 2.5:1. In an example, the method can include establishing or adjusting the low shear rate viscosity of the viscoelastic material within a range of 35 pascal-seconds (Pa·s) and 45 Pa·s.

In an example, the method can include controlling an average flow velocity of a viscoelastic material during depositing of the at least one viscoelastic droplet within a range of 1.0×10⁻³ meters per second (m/s) and 1.2×10⁻³ m/s. Detaching the print nozzle from the droplet and the receiving material at a specified acceleration can include controlling a shear rate between the print nozzle and the receiving material within a range of 25s⁻¹ and 35s⁻¹. In an example, the specified diameter of the at least one viscoelastic droplet can be within a range of 300 micrometers (μm) and 900 μm. In an example, the specified diameter of the at least one viscoelastic droplet can have a diameter within a range of 80% and 200% of an aperture diameter of the print nozzle.

This document also describes a system for printing viscoelastic ink droplets in an aqueous medium. Such a system can include or use a print nozzle manipulatable via one or more drives of a gantry toward specified coordinates in the aqueous medium. For example, the system can include or be communicatively coupled to a processor to trigger depositing or extruding of viscoelastic material. Extruding the viscoelastic material, e.g., from an aperture of the print nozzle, can form at least one viscoelastic droplet including a specified diameter. In an example, the processor can be communicatively coupled to one or more drives of the gantry. Here, the processor can actuate the one or more drives such as to detach the print nozzle from the droplet and a receiving material by translating the print nozzle relative to the droplet according to a specified acceleration. In an example, the processor can establish or adjust the position of the print nozzle such as to compensate for displacement of the at least one viscoelastic droplet away from the specified coordinates in relation to detaching the print nozzle from the droplet.

In an example, the processor can be included such as to receive imaging data corresponding with a position of the print nozzle during depositing of the at least one viscoelastic droplet onto the receiving material. In an example, reprocess the imaging data as feedback in positioning the print nozzle. In an example, the system can include one or more optical linear encoders to provide the imaging data to the processor, the one or more optical linear encoders included such as to provide the imaging data at a resolution less than 5 nanometers (nm).

The system can include a reservoir fluidly connected to the print nozzle and included such as to supply a viscoelastic material including biological material (e.g., bio-ink) to the print nozzle. The system can also include the one or more drives, e.g., a servomotor to position the print nozzle with an accuracy of less than ±2 μm on at least one plane with respect to the specified coordinates. For example, the servomotor can be actuatable for moving the print nozzle at a speed greater than 2.5 meters per second (m/s) (e.g., up to about 3 m/s) and an acceleration greater than 2 g-force (g) (e.g., up to about 2.5 (g)).

Also, the print nozzle can include a linear screw actuator to control an average flow velocity of a viscoelastic material through an aperture of the print nozzle during depositing of the at least one viscoelastic droplet. For example, at least one of the processor or the linear screw actuator can regulate an average flow velocity of a viscoelastic material during depositing of the at least one viscoelastic droplet within a range of 1.0×10⁻³ meters per second (m/s) and 1.2×10⁻³ m/s.

Each of the non-limiting examples described herein can stand on its own, or can be combined in various permutations or combinations with one or more of the other examples.

This Summary is intended to provide an overview of the subject matter of the present patent application. It is not intended to provide an exclusive or exhaustive explanation of the invention. The detailed description is included to provide further information.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present document.

FIG. 1A depicts a perspective view of an example of a system for 3D printing.

FIG. 1B depicts a side view of an example of a system for 3D printing.

FIG. 2A depicts an example of a print nozzle in use for extruding viscoelastic droplet voxels within a support matrix.

FIG. 2B depicts an example of a print nozzle in use for extruding viscoelastic droplet voxels within a support matrix.

FIG. 2C depicts an example of a print nozzle in use for extruding viscoelastic droplet voxels within a support matrix.

FIG. 3A depicts an example of a print nozzle detaching from an individual viscoelastic droplet.

FIG. 3B depicts an example of a print nozzle detaching from an individual viscoelastic droplet.

FIG. 3C depicts a moving profile of the print nozzle during extruding of an individual droplet.

FIG. 4A depicts a progression of detaching a nozzle from a droplet at a specified acceleration rate for two different droplet/nozzle diameter ratios.

FIG. 4B is a plot showing final displacements of droplets at various combinations of and nozzle accelerations.

FIG. 4C is a plot showing final displacements of droplets at various combinations of and nozzle accelerations.

FIG. 4D depicts a velocity field of the supporting matrix, droplet rotation, and droplet displacement during detachment of an exemplary print nozzle from a droplet.

FIG. 4E depicts a velocity field of the supporting matrix, droplet rotation, and droplet displacement during detachment of an exemplary print nozzle from a droplet.

FIG. 5A is a plot depicting a dependence of the displacements of the print nozzle and the droplet on time at the printing conditions during detaching of an example of a print nozzle from a droplet.

FIG. 5B is a plot depicting respective trajectories of droplets printed at a plurality of different accelerations.

FIG. 6 is a flowchart that describes a method for printing viscoelastic ink droplets in an aqueous medium.

FIG. 7 is a block diagram illustrating components of a machine.

### DETAILED DESCRIPTION

Three-dimensional (3D) printing with biocompatible materials, biological materials (e.g., mammalian cells), and supporting components (e.g., hydrogels), can be used to construct complex, functioning 3D living tissues. This technique can be referred to as bioprinting, and can be used to develop tissue models for drug testing, tissue engineering, and regenerative medicine applications. For example, biological materials printed in precise layers and patterns can create 3D structures that mimic the architecture of natural mammalian tissues. One approach to bioprinting involves an inkjet-based three-dimensional (3D) printing technique. While certain inkjet-based bioprinting techniques can be capable of creating 3D voxelated materials with relatively high precision, such techniques can present a challenge in that the physics of droplet formation requires the use of low-viscosity inks to ensure successful printing. Low viscosity inks tend to form unstable droplets during the printing process, which can lead to droplet spreading and loss of precision.

By comparison, direct ink writing techniques, e.g., an extrusion-based 3D printing method, can be capable of printing a broader range of materials. However, direct ink writing including biological materials can present technical challenges related to the rheology of the materials. For example, monodisperse emulsions or droplets can be generated by exploiting Rayleigh-Plateau instability, during which a liquid thread breaks into droplets to minimize their surface area and thus interfacial free energy. However, it can be challenging to control the position of such droplets in 3D space. This challenge can be at least partially address by embedded droplet printing, which generates and disperses aqueous droplets into an 3D gelatinous matrix (e.g., an immiscible continuous oil phase made by yield-stress fluids). Because the yield-stress fluid can reversibly transition from solid-like to liquid-like at critical stress, the fluid can stabilize and entrap a droplet once it forms, providing a certain degree of control over the droplet position in 3D space. The breakup of the dispersing fluid thread can help form discrete droplets, which can be used to generate patterns with prescribed droplet distance, but also limits a degree of control in assembling the droplets.

Another approach to bioprinting can involve lipid molecules to coat water-in-oil droplets can help promote control in assembling the droplets. As two lipid-coated droplets come together, the hydrophobic tails of the lipid molecules can “stack” to form a lipid bilayer that can cohesively join the two droplets without coalescence. This process can assist in creating a droplet network in which aqueous droplets are compartmentalized by the network of lipid bilayers. This approach also presents a challenge, however, in that since the lipid bilayer is stabilized by van der Waals force, the network is mechanically weak and cannot support relatively complex structures.

In yet another approach to bioprinting, pre-made solid-like particles can be used as building blocks can be used instead of in situ generated viscoelastic bio-ink droplets. Such an approach can help mitigate certain technological challenges associated with the on-demand generation of viscoelastic voxels. For example, the printing 3D cell aggregates, e.g., tissue spheroids, can be advantageous as compared to certain techniques using 2D cell cultures. Although delicate, such spheroids are generally solid-like and can be successfully manipulated with great care. For example, a spheroid can be gently picked up by a glass pipette under controlled vacuum aspiration, transferred to a supporting hydrogel matrix, and deposited at a prescribed location upon vacuum removal. Through cell migration, closely placed spheroids can fuse to form microtissues with pre-defined shapes. Thus, 3D bioprinting of spheroids resembles some of the features required for voxelated bioprinting but also presents inherent challenges in being limited to pre-made solid-like voxels, which can limit the types of materials that can be printed. For example, pre-made spheroids can be relatively large, making them difficult to control with requisite precision for certain bioprinting applications.

The present inventors have recognized a need for a bioprinting method capable of printing with relatively high precision and with a wide range of materials. To address this need, the inventors have developed a technique of embedded 3D printing involving voxelated bioprinting technology. Such a technique can enable the digital assembly of spherical particles (DASP). Unlike certain other embedded droplet printing techniques that are limited to dispersing low viscosity fluids in oil-based supporting matrices, DASP can, e.g., generate a highly viscoelastic bio-ink droplet in an aqueous yield-stress fluid, deposit the droplet at a prescribed location, and assemble individual droplets through controlled polymer swelling. Consequently, a DASP approach to bioprinting can help enable on-demand generation, position, and assembly of highly viscoelastic voxels in an aqueous environment. An example of a similar DASP approach for embedded 3D bioprinting is described in international patent application PCT/US2021/037811, which is incorporated herein by reference in its entirety.

This document describes a DASP approach for embedded 3D bioprinting involving printing droplets of low viscosity Newtonian liquids in an immiscible organic fluid, e.g., all-aqueous printing of viscoelastic droplets (aaPVD) in yield-stress fluids. A 3D printing system can be configured for precise control over a plurality of printing conditions. Such a 3D printing system can establish or adjust certain parameters critical to placement of an individual droplet during aaPVD, e.g., acceleration, a, of the print nozzle, and the ratio between droplet and nozzle diameters, D_{d}/Dₙ. For example, the 3D printing system include a print nozzle for extruding a viscoelastic material (e.g., a highly viscous, shear-thinning fluid) from an aperture of the print nozzle to generate a droplet. The print nozzle can be translated, e.g., via a gantry such as to detach the print nozzle from the droplet. The 3D printing system can also facilitate relaxation of the detached droplet after detachment from the print nozzle. The 3D printing system can effectively control the parameters related to placement of the individual droplet such as to generate a droplet of requisite roundness and at desired coordinates.

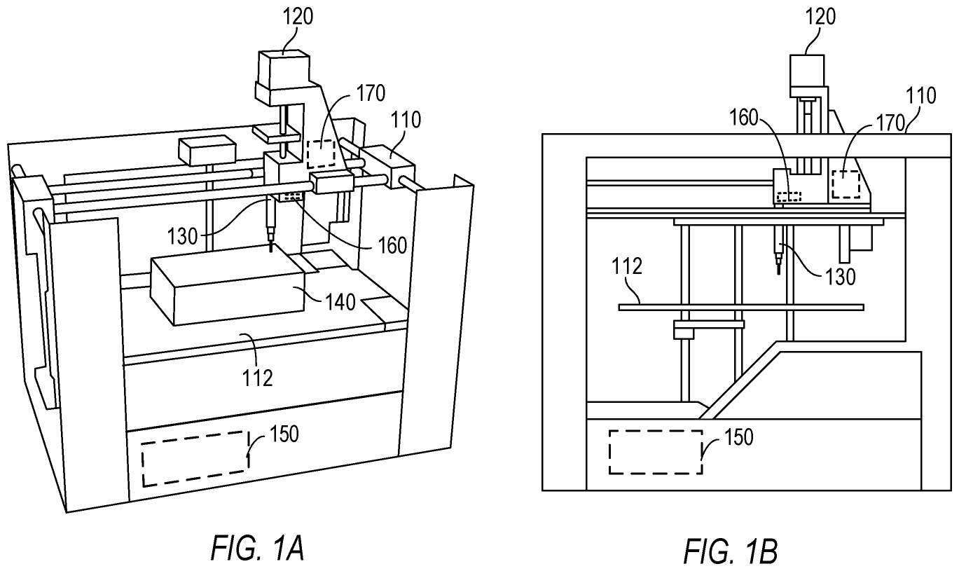

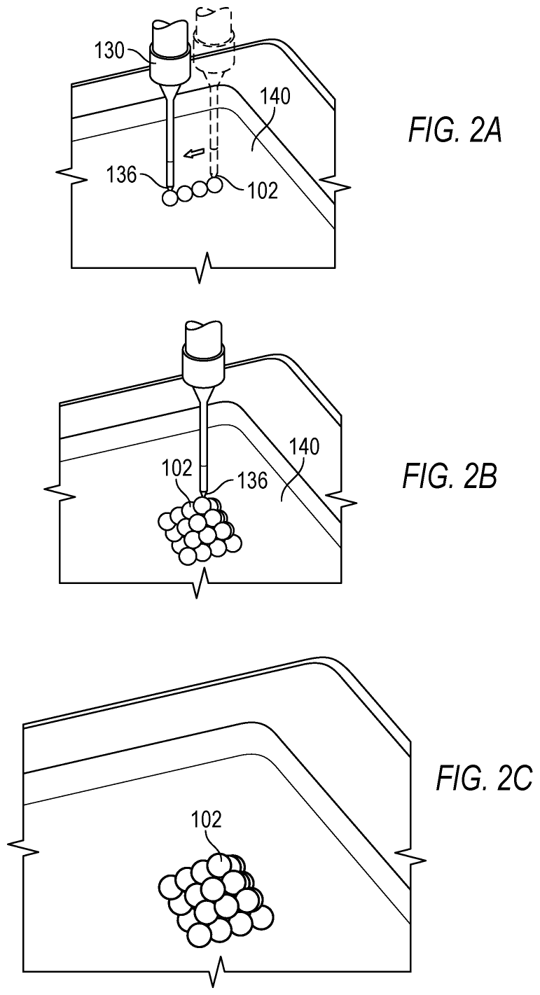

FIG. 1A and FIG. 1B depict a perspective view and a side view of an example of a system for 3D printing, respectively. The system 100 can include a print nozzle manipulator 110, a microfluidic print nozzle 130 coupled to the print nozzle manipulator 110, an extrusion device 120 fluidly coupled to the microfluidic print nozzle 130, and a system processor 150. The print nozzle manipulator 110 can be operable to position the microfluidic print nozzle 130 in 3-dimensional space, and the extrusion device 120 can be operable to mechanically extrude a hydrogel composition from the microfluidic print nozzle 130. The microfluidic print nozzle 130 can be operable to deposit a specified volume of viscoelastic material on or within a receiving material, e.g., a support matrix 140 to form an individual voxel printed within the support matrix 140. Herein, the term “viscoelastic material” can refer to a material that exhibits both viscous and elastic properties. The viscoelastic material can include a hydrogel composition that includes one or more polymers, such as polyethylene glycol, polyvinyl alcohol, polyacrylamide, hyaluronic acid, or combinations thereof, and one or more crosslinkers, such as glutaraldehyde, genipin, or combinations thereof. The viscoelastic material can also include biological material suspended therein, e.g., mammalian cells, proteins, peptides, or fragments thereof.

In an example, the print nozzle 130 can be positioned via one or more drives of the print nozzle manipulator 110. For example, the print nozzle manipulator 110 can include a gantry mechanism including a one or more horizontal drives, e.g., a linear or rotary servomotor, for adjusting a horizontal position of the print nozzle 130 with respect to the support matrix 140 or a platform for holding the matrix 140. For example, the gantry mechanism can include a pair of orthogonal linear or rotary servomotors or lead screws to move the print nozzle 130 along two mutually perpendicular axes. In an example, the print nozzle manipulator 110 can also include a vertical drive, e.g., a vertical linear or rotary servomotor, to move the print nozzle 130 up and down. The vertical drive can be used to control the height of the print nozzle 130 relative to the support matrix 140, as well as to move the print nozzle 130 to and from the support matrix 140. Alternatively or additionally, the system 100 can include one or more drives for moving a platform holding the support matrix 140 with respect to the print nozzle, e.g., raising or lowering a height of the support matrix 140. The print nozzle manipulator 110 can be configured to position the print nozzle 130 in three-dimensional space along three or more axes to form a layer of a three-dimensional structure. For example, the print nozzle manipulator 110 can position the print nozzle 130 toward specified coordinates of the receiving material, e.g., cartesian coordinates within the support matrix 140. Here, the print nozzle manipulator 110 can control the print nozzle 130 along the x, y, and z axes to disperse a set of droplets on the receiving material to form a layer of a three-dimensional structure. An example of a print nozzle manipulator is an AGS1500 gantry produced by Aerotech, Inc. In an example, the print nozzle manipulator can position the print nozzle 130 with an accuracy of about ±1.5 μm on both X and Y horizontal axes and 10 μm on a Z vertical axis. Moreover, the print nozzle manipulator 110 can be capable of being actuated to translate the print nozzle 130 at a speed of at least 2.5 m/s (e.g., about 3 m/s) at the acceleration up to 2 g-force (g) (e.g., about 2.5 (g)).

The system 100 can include the extrusion device 120. The extrusion device 120 can be fluidly coupled to the microfluidic print nozzle 130. The extrusion device 120 can be physically coupled to the print nozzle manipulator 110 such that the extrusion device 120 can be translated in conjunction with positioning of the microfluidic print nozzle 130. In an example, the extrusion device 120 can be stationary and fluidly coupled to the microfluidic print nozzle 130 through a conduit that enables movement of the microfluidic print nozzle 130 relative to the extrusion device 120. The extrusion device 120 can be operable to mechanically extrude a viscoelastic material from the microfluidic print nozzle 130 to form an individual viscoelastic droplet. In particular, the extrusion device 120 can be operable to deliver the viscoelastic material to the microfluidic print nozzle 130 using mechanical forces, where continued application of mechanical force to the hydrogel composition causes extrusion of the hydrogel composition from the tip of the microfluidic print nozzle 130. For example, the extrusion device 120 can include or use a motorized syringe pump or a linear screw (T8) actuator to mechanically extrude the hydrogel. For example, the linear screw actuator can convert a rotary motion of a stepper motor into linear motion. In an example, the extrusion device 120, the print nozzle 130, or both can be fluidly coupled to a reservoir 170 to supply the viscoelastic material for droplet printing via extrusion.

In an example, the processor 150 can be included such as to facilitate digital assembly of spherical particles (DASP) to establish the three-dimensional (3D) structure. For example, the processor 150 can be included such as to facilitate DASP to assemble 3D mammalian biological material included in biological material model. The processor 150 can control translation the print nozzle 130 in 3D space, e.g., by actuating the one or more drives of the print nozzle manipulator 110. For example, processor 150 can control the print nozzle 130 along the x, y, and z axes to disperse a set of droplets on the receiving material to form a layer of a three-dimensional structure. Here, processor 150 can be configured to generate control signals for controlling the print nozzle 130 and the print nozzle manipulator 110. The control signals can include, e.g., signals to direct the print nozzle 130 to a desired location or coordinates in 3D space, signals to control a speed and acceleration of the print nozzle 130, signals to control a size of the droplets dispensed from the print nozzle 130, etc. The control signals can be generated by the processor 150 based on 3D-printing instructions stored in a memory. The 3D-printing instructions can be generated based on a 3D-printing file that includes a set of three-dimensional printing commands, e.g., commands to form a layer of a three-dimensional structure. The 3D-printing instructions can include, e.g., commands to direct the print nozzle 130 to a desired location in 3D space, commands to control a speed and acceleration of the print nozzle 130, commands to control a size of the droplets dispensed from the print nozzle 130, etc. For example, the specified acceleration can be within a range of about 0.1 meters per second squared (m/s²) and about 25 m/s². The specified acceleration can be within a range of about 5 m/s² and about 15 m/s², or more specifically within a range of about 9 m/s² and about 11 m/s².

In an example, the 3D-printing instructions can be configured based on one or more parameters of the three-dimensional structure, e.g., a size, a shape, a resolution, and/or a strength of the three-dimensional structure. In an example, the processor 150 can establish or adjust the position of the print nozzle 130 to such as to compensate for displacement of the at least one viscoelastic droplet away from the specified coordinates in relation to detaching the print nozzle 130 from the droplet. The processor 150 can also control the print nozzle manipulator 110 such as to regulate a shear rate of the extruded viscoelastic material between the print nozzle 130 and the support matrix 140 within a range of about 25 s⁻¹ and about 35 s⁻¹.

The processor 150 can also be configured to control the dispersion of the droplets from the print nozzle 130 an into the receiving material, e.g., by controlling the extrusion device 120 and triggering depositing viscoelastic material from the extrusion device 120 to form at least one viscoelastic droplet. For example, the processor 150 can establish or adjust a specified flow velocity of a viscoelastic material through an aperture in the print nozzle 130. For example, the processor 150 can regulate an average flow velocity of a viscoelastic material through the aperture of the print nozzle, e.g., by actuating during depositing of the at least one viscoelastic droplet within a range of about 1.0×10⁻³ meters per second (m/s) and about 1.2×10⁻³ m/s.

In an example, the processor 150 can be communicatively coupled to at least one sensor or camera 160 such as to receive imaging data therefrom. Here, the imaging data can correspond with a position of the print nozzle 130 during depositing of the at least one viscoelastic droplet onto or within the support matrix 140. For example, the imaging data can be used by the processor 150 as feedback in positioning the print nozzle 130 via the print nozzle manipulator 110. In an example, the at least one sensor 160 can include one or more optical linear encoders to provide the imaging data to the processor 150. Such an optical linear encoder can provide the imaging data at a resolution less than 5 nanometers (nm).

The support matrix 140 can include physical and chemical properties to promote printing of the viscoelastic droplets via the print nozzle 130. The support matrix 140 can be aqueous and substantially cytocompatible. The support matrix 140 can be formed of a yield stress fluid such that under stress the support matrix 140 becomes fluid-like, e.g., allowing the movement of the printing nozzle therethrough. In an example, the support matrix 140 can “self-heal” to revert to its previous mechanical properties within a relatively short time (e.g., <1 seconds) such as to localize a deposited droplet. In an example, the support matrix 140 can provide an environment such that individual viscoelastic droplets will swell and at least partially coalesce with one another. The support matrix 140 can also be removed after printing or cross-linking of the viscoelastic droplets.

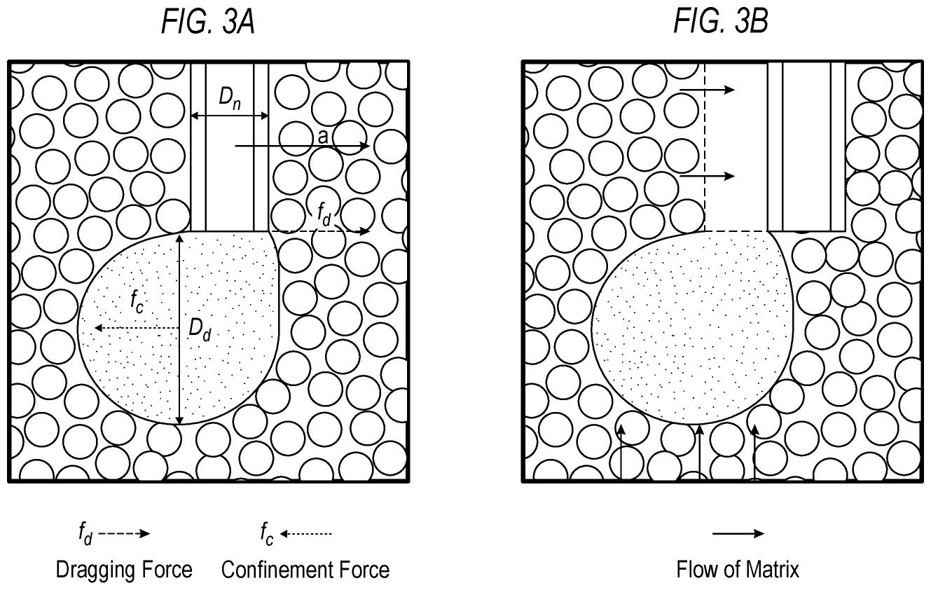

FIG. 2A, FIG. 2B, and FIG. 2C depict an example of a print nozzle in use for extruding viscoelastic droplet voxels within a support matrix. In operation and use, the print nozzle 130 can be manipulated toward first coordinates such as to deposit or extrude a sequence of viscoelastic droplet voxels 102. After depositing one viscoelastic droplet voxel 102, the microfluidic print nozzle 130 can be horizontally translated, e.g., to second coordinates, such as to deposit another hydrogel voxel. In an example, a forward and backward motion can be used to detach the tip 136 of the nozzle 130 from an individual viscoelastic droplet voxel 102 and reposition the microfluidic print nozzle 130 at the next position in the support matrix 140. In another example, the specified acceleration in a single direction can be used to detach the tip 136 of the nozzle 130 from the individual viscoelastic droplet voxel 102. In an example, the nozzle 134 can be moved away from the individual voxel 102 by at least 3 mm or at least 3.5 mm to help promote detachment.

The viscoelastic droplet voxels 102 can be extruded by the print nozzle 130 in a substantially spherical shape. For example, each of the points on the outer surface of each of the plurality of viscoelastic droplet voxels 102 can be established within 11% of an average radius of the hydrogel voxels at the time the hydrogel voxels are deposited and before any swelling of the hydrogel voxels.

The print nozzle 130 can be manipulated such as to extrude an individual viscoelastic droplet voxel 102 at an average diameter within a range of about 150 μm to about 1200 μm after swelling. For example, the voxel 102 can be extruded at an average diameter within a range of about 300 μm and about 900 μm. The average diameter of the viscoelastic droplet voxels 102 can depend on the volume of hydrogel composition extruded for each viscoelastic droplet voxel 102. In an example, the print nozzle 130 can extrude an individual viscoelastic droplet voxel 102 at a volume within a range of about 16 nanoliters (nL) to about 418 nL.

After extrusion via the print nozzle 130, the viscoelastic droplet voxels 102 can “rest” in the support matrix 140 for a specified time (e.g., about 3 minutes), the support matrix 140 can be removed and the viscoelastic droplet voxels 102 can be cross-linked, e.g., through washing the printed structure with a calcium solution. Each of the spherical viscoelastic droplet voxels 102 can be interconnected and can be distinguishable from each other when viewed through optical microscopy within about one hour of cross-linking the viscoelastic droplet voxels 102 or washing the viscoelastic droplet voxels 102.

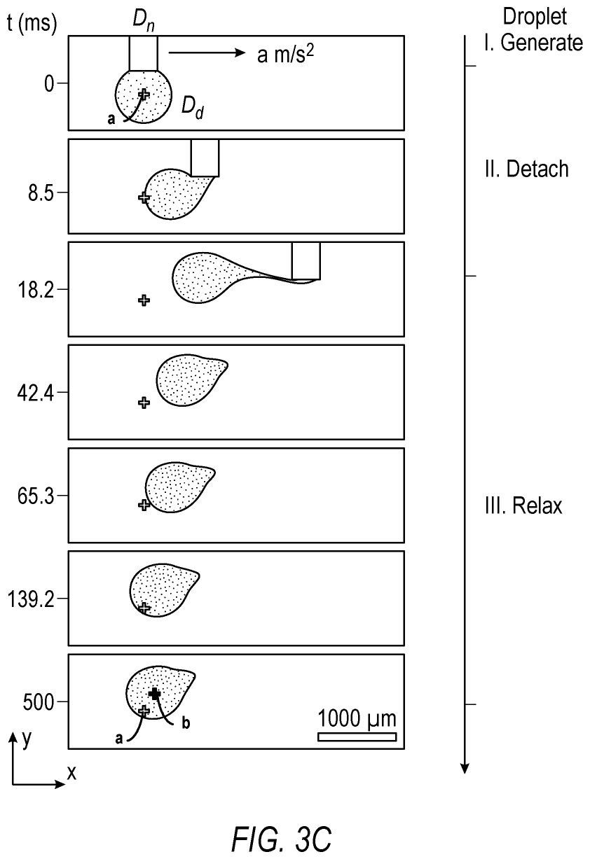

FIG. 3A and FIG. 3B depict an example of a print nozzle detaching from an individual viscoelastic droplet. As depicted, an individual droplet can be subject to two competing forces: (1) the dragging force associated with separating the print nozzle from the droplet, and (2) confinement force from the supporting matrix exerted on the droplet. For the final displacement along the movement of nozzle, Δx_{f}, the droplet is subject to at least two forces during the detachment process: a dragging force f_{d} from the nozzle, and a confinement force f, from the supporting matrix, as illustrated in FIG. 3A. The dragging force can be determined by fracturing the connection between the nozzle tip and the droplet, which is proportional to the product of the contact area, Dₙ², and the effective shear modulus of alginate ink, G_{i,e}:

f_{d}≈G_{i,e}Dₙ²

Here, unlike a particle moving in viscous liquids that experiences friction determined by the fluid viscosity, the droplet can be confined in a yield-stress fluid, which can effectively exhibit properties of an elastic solid below the yield stress. As such, the droplet can be mechanically constrained in the supporting matrix. The confinement force f_{c} is the product of the droplet cross area, D_{d}², and the effective modulus of the matrix, G_{m,e}:

f_{c}≈G_{m,e}D_{d}²

Because both the supporting matrix and the viscoelastic droplet include viscoelastic fluids, their effective moduli can be dependent on the probing time scale, τₚ. In an example, the print nozzle can move at a constant acceleration a. Therefore, the probing time scale associated with our droplet printing can be expressed as:

$${τ}_{p} \approx {( {D}_{d} / a )}^{1 / 2}$$

Alternatively, the probing time scale can be expressed in the context of materials deformation rate. As the print nozzle accelerates, it deforms the droplet at a rate of

$${( \frac{a}{{D}_{d}} )}^{1 / 2} .$$

Here, the droplet tends to displace the supporting matrix at an acceleration of a, reminiscent of inertia force from Newton's second law. Consequently, the supporting matrix is effectively deformed by the droplet at a rate of

$${( \frac{a}{{D}_{d}} )}^{1 / 2} ,$$

which is the reciprocal of the probing time scale.

The effective moduli at the probing time scale can be based on the experimentally measured shear storage moduli from oscillatory shear measurements. The probing time scale τₚ is the inverse of the angular frequency or rotation rate of the geometry, ω≈1/τₚ; therefore, shear storage moduli can be mapped for both the ink and the supporting matrix at each printing condition. This can enable a determination of the ratio between the dragging force and the confinement force applied to the droplet:

$$\frac{{f}_{d}}{{f}_{c}} \approx \frac{{D}_{n}^{2} {G}_{i , e} ( \frac{1}{{τ}_{p}} )}{{D}_{d}^{2} {G}_{m , e} ( \frac{1}{{τ}_{p}} )}$$

This relation shows that Δx_{f} can be reduced by decreasing the ratio between dragging and confinement forces, which can be achieved by at least three methods: (1) using relatively low nozzle acceleration, (2) increasing droplet to nozzle diameter ratio D_{d}/Dₙ, or (3) increasing the stiffness of the supporting matrix.

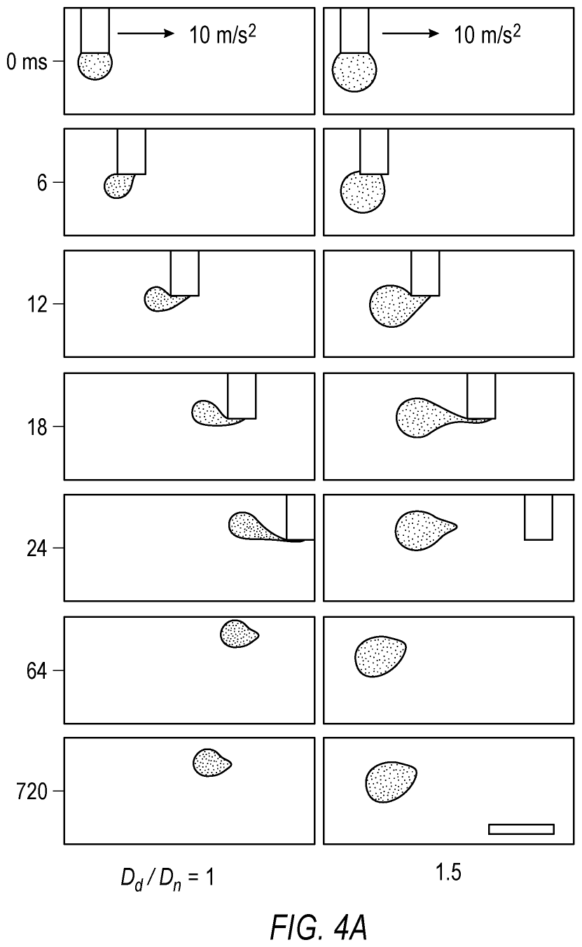

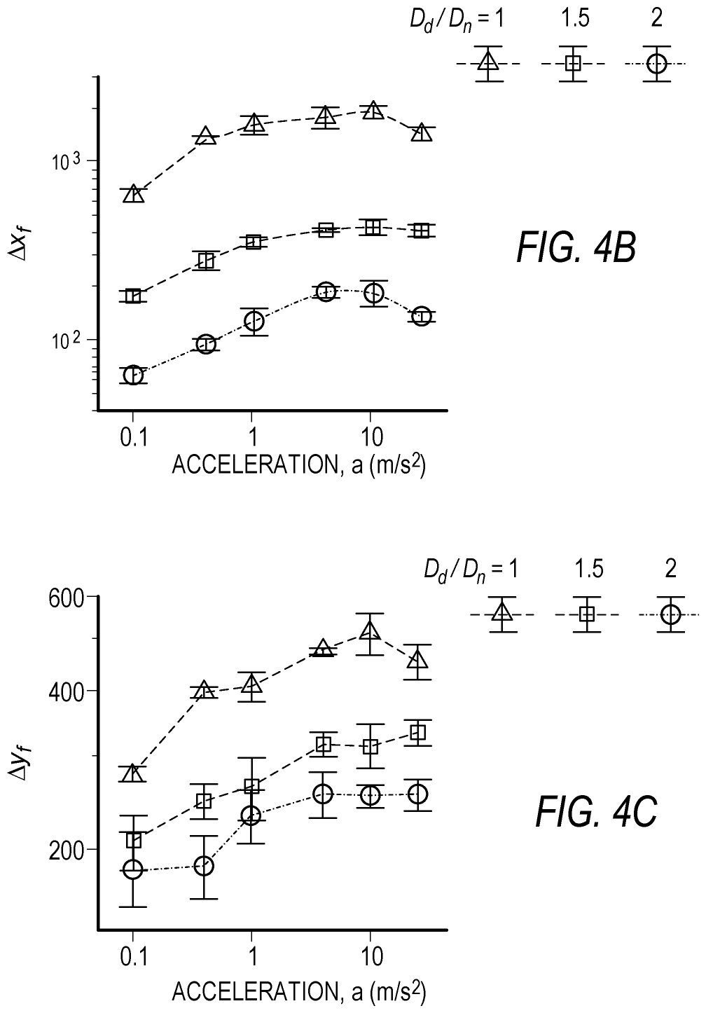

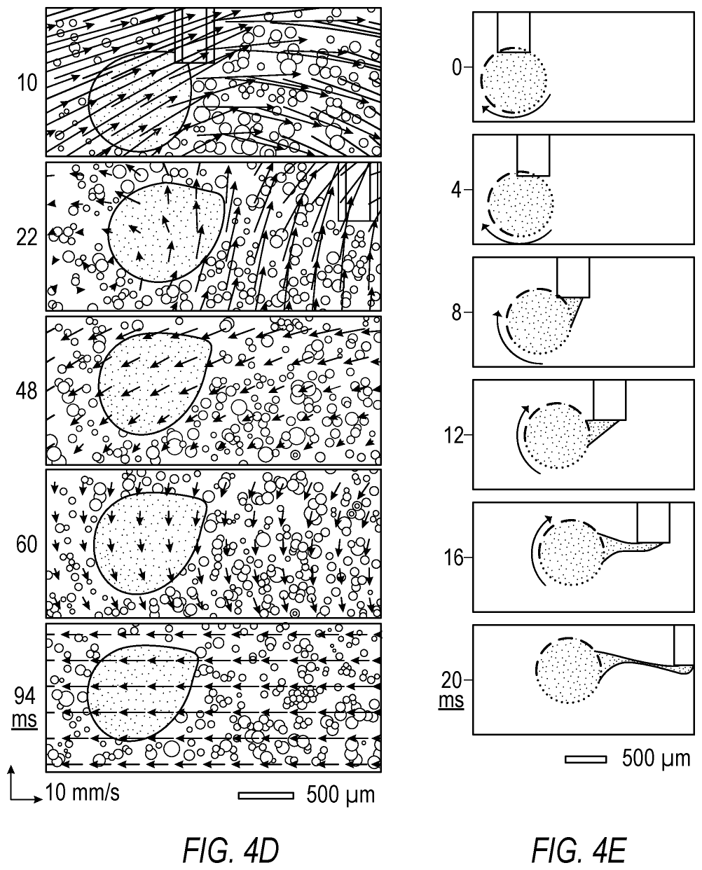

Unlike Δx_{f}, which is highly dependent on the dragging force, along y axis the droplet does not experience the dragging force from the print nozzle. However, the competition between the dragging force and the confinement force generates a torque, as illustrated in FIG. 3A. This torque results in the rotation of the droplet, as depicted in FIG. 4E. Notably, as the nozzle translates, it can leave a substantially empty space behind the nozzle, as schematically illustrated in FIG. 3B. This space can be filled by the supporting matrix near the print nozzle. Thus, the droplet can move along with the matrix flow, resulting in a displacement of the droplet along y direction. Indeed, this effect also shown by PIV analysis, as shown in FIG. 4D, by the velocity fields of the supporting matrix and the droplet position at about 10 ms. Such results suggest that Δy_{f} is highly correlated to flow of the supporting matrix, which is significantly affected by yielded area near the print nozzle.

The shear rate of the supporting matrix is approximately equal to the ratio between the nozzle velocity Uₙ and the nozzle diameter: \dot{γ}=Uₙ/Dₙ. Because the nozzle moves at constant acceleration a, the average velocity can be used when the nozzle moves by the droplet diameter D_{d}, beyond which the nozzle starts to separate from the droplet: Uₙ≈(D_{d}a)^{1/2}. Thus, for a given set of printing conditions (nozzle diameter, droplet diameter, and nozzle acceleration), the Oldroyd number can be expressed as:

$$Od \approx \frac{{σ}_{y}}{{{K}_{m} [ {( {D}_{d} a )}^{1 / 2} / {D}_{n} ]}^{n}}$$

Because the Oldroyd number can characterize the yielded area near the print nozzle, the cross area traveled by the droplet can be plotted along y axis, Δy_{f}D_{d}, against the Oldroyd number. Moreover, two regimes can be identified for the dependence of Δy_{f}D_{d} on the Oldroyd number. For small values with Od<0.3, Δy_{f}D_{d} can remain nearly constant. By contrast, at relatively large values with Od>0.3, Δy_{f}D_{d} can decrease with the increase of Oldroyd number by a power of −0.6. The universal dependence of the droplet displacement area on the Oldroyd number can indicate that Δy_{f} can be reduced by at least three methods: (1) decrease the nozzle acceleration, (2) increase droplet to nozzle diameter ratio D_{d}/Dₙ, or (3) increase the yield stress of the supporting matrix. Similar methods exist for reducing both Δx_{f} and Δx_{y}: (1) increasing droplet to nozzle diameter ratio D_{d}/Dₙ, (2) increase the yield-stress and the stiffness of the supporting matrix, or (3) use a relatively high nozzle acceleration.

FIG. 3C depicts a moving profile of the print nozzle during extruding of an individual droplet. In an example of a printing process, the print nozzle can be positioned at a specified location to extrude a droplet with a specified diameter D_{d}. The nozzle can then be detached from the droplet at a controlled acceleration a. The droplet can be allowed to relax, as shown by the progression in FIG. 3C. A fidelity of droplet printing can be characterized by at least two parameters: (1) droplet roundness at the generation stage and after relaxation, and (2) final droplet displacement after relaxation (distance between crosses a and b in FIG. 3C).

Embedded droplet printing can involve depositing a droplet not only at prescribed location but also with a requisite roundness. The morphology of a relaxed droplet (Stage III in as depicted in FIG. 3C) is largely determined by the detachment stage, where an extruded droplet can be deformed by the print nozzle. During this process, the nozzle can shear the droplet or can pull a “string” from the droplet to form a tadpole-like morphology. Moreover, the length of the tail of the tadpole-like pattern decreases with the increase of the nozzle acceleration. This is because at higher accelerations, or shorter probing time scales, the viscoelastic droplet has less time to relax, such that the droplet is more solid-like and less prone to flow with the nozzle.

The morphology of relaxed droplet can be characterized in terms of droplet roundness [symbol] , which can be defined as the ratio between the length and head width of the droplet, [symbol] =L/W. The larger the value of [symbol] , the less round the droplet is. Generally, the droplet roundness decreases with increase of the droplet/nozzle diameter ratio D_{d}/Dₙ. As such, increasing droplet size can generally promote a formation of a rounder droplet, and a higher fidelity of droplet printing.

However, the absolute length of the droplet tail, L-D_{d}, is generally not related to droplet size but is rather determined primarily by the nozzle acceleration. At or near a relatively low nozzle acceleration, e.g., a=0.1 m/s², the tail is relatively long and is generally beyond a desired range. At or near very high acceleration, e.g., a=25 m/s², a tail does not form significantly, and such a tail will generally have a length less than 5% of the droplet diameter. A “crossover” acceleration can also be characterized, a≈2 m/s², above which the tail length is relatively small and decreases slowly with the increase of nozzle acceleration. At this crossover acceleration, viscoelastic material is pulled by the print nozzle at a probing time scale, τₚ≈(Dₙ/a)^{1/2}≈10 ms, which is comparable to the relaxation time of the alginate ink, τᵣₑₗₐₓ≈1/Ω_{c}≈25 ms, where Ω_{c} is the crossover frequency below which G″ is higher than G″. An exemplary approach to print a droplet of good roundness, thus, involves the print nozzle moving at relatively high accelerations to ensure that the probing time scale is shorter than the relaxation time of viscoelastic material, such the droplet does not have time to relax and flow with the nozzle.

Such an approach can further involve: (1) providing a relatively large droplet/nozzle diameter ratio, (2) providing a relatively stiff supporting matrix with high yield stress, and (3) controlling intermediate nozzle acceleration, at which the associated probing time scale is shorter than the relaxation time of the viscoelastic ink but not too short to result in large dragging force.

FIG. 4A depicts a progression of detaching a nozzle from a droplet at a specified acceleration rate for two different droplet/nozzle diameter ratios, D_{d}/Dₙ. In the depicted example, the print nozzle diameter is be fixed at Dₙ=440 μm, yet the droplet diameter D_{d} varies from 440 μm (left column) to 660 μm (right column). This illustrates how a relatively large droplet diameter D_{d} is related to a decrease horizontal displacement of a viscoelastic droplet in within the support matrix.

FIG. 4B and FIG. 4C are plots showing respective final displacements of droplets at various combinations of D_{d}/Dₙ, and nozzle accelerations. FIG. 4B shows the displacement along the moving direction of nozzle, Δx_{f}; While FIG. 4C shows the displacement along the nozzle axis, Δy_{f}. The error bars in FIG. 4B and FIG. 4C represent a standard deviation (STD), n=3. As a droplet moves through the supporting matrix, the droplet experiences friction that increases with the droplet diameter. Therefore, in addition to nozzle acceleration, the droplet size can affect a final displacement of a droplet. As depicted, varying droplet/nozzle diameter ratios of D_{d}/Dₙ, =1.0, 1.5, and 2.0, respectively can have significant effects on displacement in both Δx_{f} and Δy_{f} directions. Here, respective increasingly larger final displacements are related to increasingly smaller droplet sizes. Similar trends exist for other various nozzle accelerations within a range from about 0.1 toward about 25 m/s². However, regardless of the acceleration, the relative increase in the final droplet displacement is nearly the same: as D_{d}/Dₙ, decreases from 2 to 1.0, Δx_{f} increases significantly by approximately a factor of 10 (FIG. 4B), whereas Δy_{f} increases by approximately a factor of 2 (FIG. 4C).

The final droplet displacement exhibits a nonmonotonic dependence on the nozzle acceleration. For example, at D_{d}/Dₙ=2.0, the Δx_{f} increases from 55 μm at 0.1 m/s2 to 186 μm at 4 m/s2 and then decreases to 135 μm at 25 m/s2 (see., e.g., circles in FIG. 4B). By contrast, Δy_{f} increases monotonically by nearly 50% from 190 μm from 260 μm as a increases from 0.1 to 4 m/s2 but saturates at higher accelerations (see, e.g., circles in FIG. 4C). Moreover, similar trends exist for different D_{d}/Dₙ, values: both Δx_{f} and Δy_{f} initially increase with a but either saturate or slightly decrease at high a. Such results mitigate the droplet displacement in a viscous fluid, which would increase if the droplet were pulled at higher accelerations or by larger forces.

FIG. 4D and FIG. 4E depict a velocity field of the supporting matrix, droplet rotation, and droplet displacement during detachment of an exemplary print nozzle from a droplet. As depicted in FIG. 4D, an example PIV analysis shows a velocity field of the supporting matrix during the droplet detachment stage, with a nozzle tip diameter of about Dₙ=440 μm, and a droplet diameter of about D_{d}=880 μm. As depicted in FIG. 4D by the white dots, silica beads (e.g., with a diameter of about 50 μm) can be used as tracers for PIV analysis. The arrows in FIG. 4D indicate the absolute velocity field of the supporting matrix near the droplet. As depicted in FIG. 4E, a time-series of photographs show that a droplet rotates and displaces under the dragging from the nozzle.

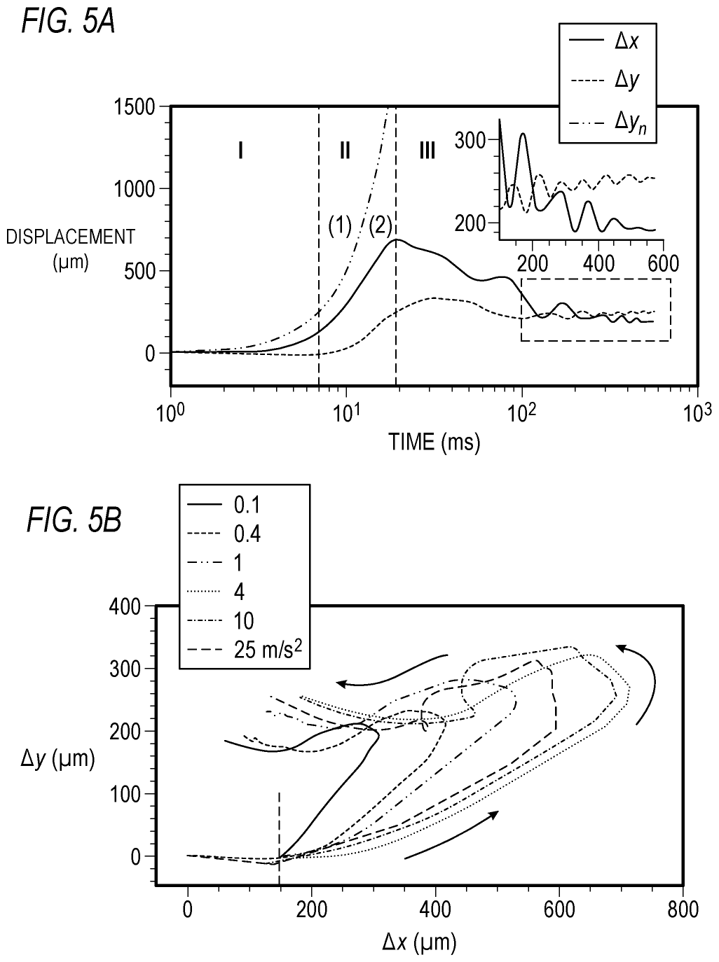

FIG. 5A is a plot depicting a dependence of the displacements of the print nozzle and the droplet on time at the printing conditions during detaching of an example of a print nozzle from a droplet. FIG. 5B is a plot depicting respective trajectories of droplets printed at a plurality of different accelerations. As depicted in FIG. 5A, Δxₙ is the displacement of the nozzle; Δx and Δy are, respectively, the displacements of the droplet along the moving direction of the nozzle and along the nozzle axis. Here, a flow of the supporting matrix is related to the trajectory of the droplet. Initially, as the print nozzle accelerates, the support matrix mainly flows along the direction of nozzle movement (e.g., in the x direction). This corresponds with a droplet trajectory in Regime I where the droplet displaces predominately along the x direction (FIG. 5A). Subsequently, the matrix continues to flow along with the nozzle, but can flow upward along y direction to fill the empty space left behind the nozzle, as shown at 10 ms in FIG. 4D. Concurrently, the droplet can rotate at a degree (e.g., approaching about 90°), as shown by the photographs of droplets in FIG. 4E. This behavior is related to the droplet trajectory in Regime II, where the droplet moves along both x and y directions (as depicted in FIG. 5A). As the nozzle is separated from the droplet and continuing to move away from the droplet, the matrix “bounces back” through a damping process, during which the matrix oscillates along the x direction as a result of the deformation caused by the nozzle movement, as shown at >20 ms in FIG. 4D. Such velocity fields of the matrix are related to the damping trajectory of the droplet in Regime III (as depicted in FIG. 5A).

The relation between matrix flow and droplet trajectory indicates that the droplet displacement consists of both recoverable and irrecoverable parts. The recoverable displacement is determined by the reversible, elastic deformation of the supporting matrix, during which the droplet moves together with the surrounding matrix flow. This recoverable displacement is associated with Regimes II and III when the nozzle has been completely detached from the droplet. By contrast, the irrecoverable displacement is determined by the irreversible deformation of the supporting matrix, during which the droplet not only is dragged by the nozzle but also moves along with the flow of the supporting matrix near the nozzle. Importantly, the flow is attributed to the rearrangement of microgel particles, which occurs after microgel particles being yielded and displaced by the nozzle. Such an irrecoverable droplet displacement is associated with Regimes I and II where the nozzle remains in contact with the droplet.

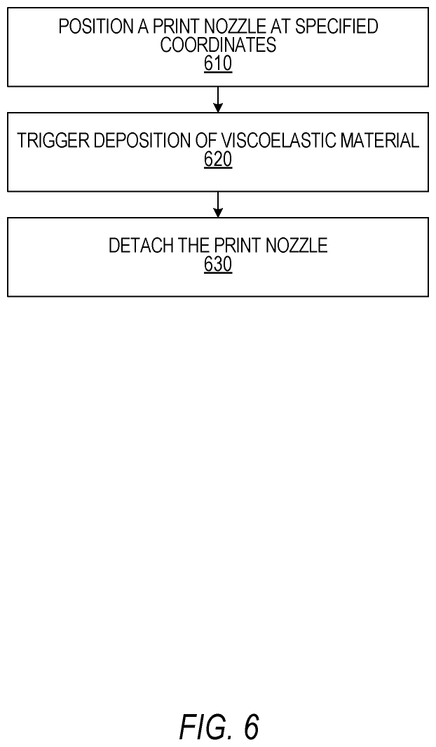

FIG. 6 is a flowchart that describes a method for printing viscoelastic ink droplets in an aqueous medium.

In an example, at 610, the method can include positioning a print nozzle at specified coordinates in the aqueous medium. For example, positioning the print nozzle can include at least one of translating or rotating the print nozzle toward the specified coordinates. Such specified coordinates can comprise first coordinates corresponding to a first pixel or a first voxel from an image defining a three-dimensional (3D) structure to be printed. Positioning the print nozzle can also include establishing or adjusting the position of the print nozzle to compensate for displacement of the at least one viscoelastic droplet away from the specified coordinates in relation to detaching the print nozzle from the droplet.

At 620, the method can include triggering deposition of viscoelastic material to form at least one viscoelastic droplet comprising a specified diameter, the deposition established by delivering a specified flow velocity of a viscoelastic material through an aperture in the print nozzle. For example, the specified diameter of the at least one viscoelastic droplet can be within a range of about 300 micrometers (μm) and about 900 μm. In an example, the specified diameter of the at least one viscoelastic droplet can have a diameter within a range of 80% and 200% of an aperture diameter of the print nozzle.

At 630, the method can include detaching the print nozzle from the droplet and a receiving material by translating the print nozzle relative to the droplet according to a specified acceleration. For example, detaching the print nozzle from the droplet and the receiving material at a specified acceleration can include controlling a shear rate between the print nozzle and the receiving material within a range of about 25 s⁻¹ and about 35s⁻¹. The specified acceleration can be within a range of about 0.1 meters per second squared (m/s²) and about 25 m/s².

In an example, the method can include controlling an average flow velocity of a viscoelastic material during depositing of the at least one viscoelastic droplet within a range of about 1.0×10⁻³ meters per second (m/s) and about 1.2×10⁻³ m/s.

In an example, at 610, the method can include performing digital assembly of spherical particles (DASP) to establish the three-dimensional (3D) structure. The method can include establishing or adjusting the specified acceleration to regulate a roundness of the deposited at least one viscoelastic droplet to length/width ratio within a range from about 1:1 to about 2.5:1. The method can include establishing or adjusting the low shear rate viscosity of the viscoelastic material within a range of about 35 pascal-seconds (Pa·s) and about 45 Pa·s.

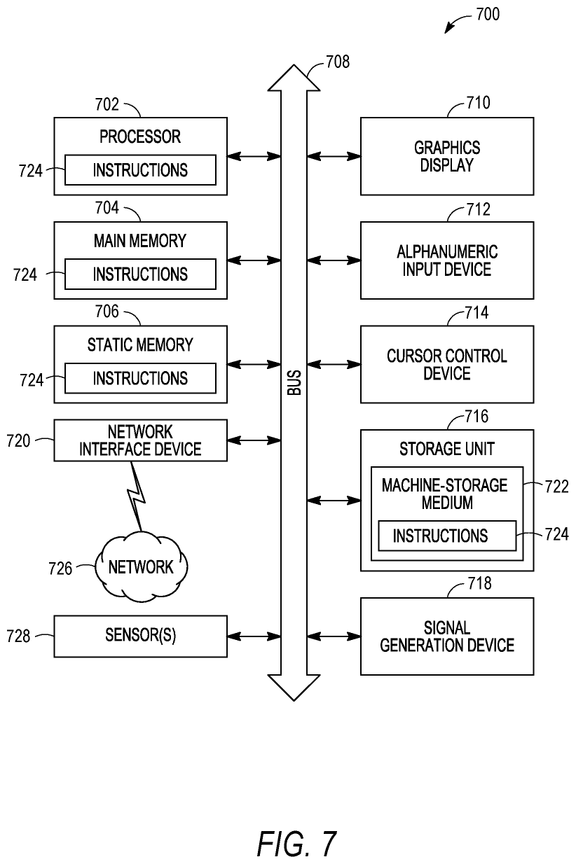

FIG. 7 is a block diagram illustrating components of a machine 700, according to some example examples, able to read instructions 724 from a machine-storage medium 722 (e.g., a non-transitory machine-storage medium, a machine-storage medium, a computer-storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein can be executed, in whole or in part. For example, the instructions 724 can be processor executable instructions that, when executed by a processor of the machine 700, cause the machine 700 to perform the operations outlined above.

In various examples, the machine 700 operates as a standalone device or can be communicatively coupled (e.g., networked) to other machines. In a networked deployment, the machine 700 can operate in the capacity of a server machine or a client machine in a server-client network environment, or as a peer machine in a distributed (e.g., peer-to-peer) network environment. The machine 700 can be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 can contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 can be configurable to execute one or more modules (e.g., software modules) described herein.

The machine 700 can further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 can also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, any suitable combination thereof, or any other suitable signal generation device), and a network interface device 720.

The storage unit 716 includes the machine-storage medium 722 (e.g., a tangible and non-transitory machine-storage medium) on which are stored the instructions 724, embodying any one or more of the methodologies or functions described herein. The instructions 724 can also reside, completely or at least partially, within the main memory 704, within the processor 702 (e.g., within the processor's cache memory), or both, before or during execution thereof by the machine 700. Accordingly, the main memory 704 and the processor 702 can be considered machine-storage media (e.g., tangible and non-transitory machine-storage media). The instructions 724 can be transmitted or received over the network 726 via the network interface device 720. For example, the network interface device 720 can communicate the instructions 724 using any one or more transfer protocols (e.g., Hypertext Transfer Protocol (HTTP)).

In some example examples, the machine 700 can be a portable computing device, such as a smart phone or tablet computer, and have one or more additional input components (e.g., sensors 728 or gauges). Examples of the additional input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components can be accessible and available for use by any of the modules described herein.

### Executable Instructions and Machine-Storage Medium

The various memories (i.e., 704, 706, and/or memory of the processor(s) 702) and/or storage unit 716 can store one or more sets of instructions and data structures (e.g., software) 724 embodying or utilized by any one or more of the methodologies or functions described herein. These instructions, when executed by processor(s) 702 cause various operations to implement the disclosed examples.

As used herein, the terms “machine-storage medium,” “device-storage medium,” “computer-storage medium” (referred to collectively as “machine-storage medium 722”) mean the same thing and can be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and can be used interchangeably in this disclosure. The terms are defined to include both machine-storage media and signal media. Thus, the terms include both storage devices/media and carrier waves/modulated data signals.

The following, non-limiting examples, detail certain aspects of the present subject matter to solve the challenges and provide the benefits discussed herein, among others.

Aspect 1 is a method for printing viscoelastic ink droplets in an aqueous medium, the method including: positioning a print nozzle at specified coordinates in the aqueous medium; triggering deposition of viscoelastic material to form at least one viscoelastic droplet including a specified diameter, the deposition established by delivering a specified flow velocity of a viscoelastic material through an aperture in the print nozzle; and detaching the print nozzle from the droplet and a receiving material by translating the print nozzle relative to the droplet according to a specified acceleration; wherein the droplet is captive on or within the receiving material located in the aqueous medium.

In Aspect 2, the subject matter of Aspect 1 includes, wherein the specified coordinates include first coordinates corresponding to a first pixel or a first voxel from an image defining a three-dimensional (3D) structure to be printed; wherein positioning the print nozzle includes establishing or adjusting the position of the print nozzle to compensate for displacement of the at least one viscoelastic droplet away from the specified coordinates in relation to detaching the print nozzle from the droplet.

In Aspect 3, the subject matter of Aspect 2 includes, performing digital assembly of spherical particles (DASP) to establish the three-dimensional (3D) structure including the at least one deposited viscoelastic droplet.

In Aspect 4, the subject matter of Aspect 3 includes, wherein: the at least one viscoelastic droplet includes a bio-ink; and performing DASP includes assembling a plurality of viscoelastic droplets to establish a biological material model.

In Aspect 5, the subject matter of Aspect 4 includes, wherein the biological material model includes 3D mammalian biological material.

In Aspect 6, the subject matter of Aspects 1-5 includes, wherein positioning the print nozzle includes at least one of translating or rotating the print nozzle toward the specified coordinates; and wherein the receiving material includes a three-dimensional (3D) supporting matrix.

In Aspect 7, the subject matter of Aspects 1-6 includes, wherein positioning the print nozzle includes: imaging the depositing of the at least one viscoelastic droplet onto the receiving material; and using the imaging as feedback in positioning the print nozzle.

In Aspect 8, the subject matter of Aspects 1-7 includes, wherein the specified acceleration is within a range of 0.1 meters per second squared (m/s²) and 25 m/s².

In Aspect 9, the subject matter of Aspects 1-8 includes, establishing or adjusting the specified acceleration to regulate a roundness of the deposited at least one viscoelastic droplet to length/width ratio within a range from 1:1 to 2.5:1.

In Aspect 10, the subject matter of Aspect 9 includes, the techniques described herein relate to a method, including establishing or adjusting the low shear rate viscosity of the viscoelastic material within a range of 35 pascal-seconds (Pa·s) and 45 Pa·s.

In Aspect 11, the subject matter of Aspects 1-10 includes, controlling an average flow velocity of a viscoelastic material during depositing of the at least one viscoelastic droplet within a range of 1.0×10⁻³ meters per second (m/s) and 1.2×10⁻³ m/s.

In Aspect 12, the subject matter of Aspects 1-11 includes, wherein detaching the print nozzle from the droplet and the receiving material at a specified acceleration includes controlling a shear rate between the print nozzle and the receiving material within a range of 25 s⁻¹ and 35s⁻¹.

In Aspect 13, the subject matter of Aspects 1-12 includes, wherein the specified diameter of the at least one viscoelastic droplet is within a range of 300 micrometers (μm) and 900 μm.

In Aspect 14, the subject matter of Aspects 1-13 includes, wherein the specified diameter of the at least one viscoelastic droplet has a diameter within a range of 80% and 200% of an aperture diameter of the print nozzle.

Aspect 15 is a system for printing viscoelastic ink droplets in an aqueous medium, the system including: a print nozzle configured to be positioned via one or more drives of a gantry toward specified coordinates in the aqueous medium; and a processor configured to: trigger depositing viscoelastic material to form at least one viscoelastic droplet including a specified diameter, the deposition established by delivering a specified flow velocity of a viscoelastic material through an aperture in the print nozzle; and actuate the one or more drives of a gantry to detach the print nozzle from the droplet and a receiving material by translating the print nozzle relative to the droplet according to a specified acceleration; wherein the droplet is captive on or within the receiving material located in the aqueous medium.

In Aspect 16, the subject matter of Aspect 15 includes, wherein the specified coordinates include first coordinates corresponding to a first pixel or a first voxel from an image defining a three-dimensional (3D) structure to be printed; wherein the processor is configured to establish or adjust the position of the print nozzle to compensate for displacement of the at least one viscoelastic droplet away from the specified coordinates in relation to detaching the print nozzle from the droplet.

In Aspect 17, the subject matter of Aspect 16 includes, wherein the processor is configured to facilitate digital assembly of spherical particles (DASP) to establish the three-dimensional (3D) structure including the at least one deposited viscoelastic droplet.

In Aspect 18, the subject matter of Aspect 17 includes, wherein the print nozzle is fluidly coupled to a reservoir configured to supply a viscoelastic material including bio-ink to the print nozzle; and wherein the processor is configured to facilitate DASP including assembling a plurality of viscoelastic droplets using, the supplied viscoelastic material, to establish a biological material model.

In Aspect 19, the subject matter of Aspect 18 includes, wherein the processor is configured to facilitate DASP to assemble 3D mammalian biological material included in biological material model.

In Aspect 20, the subject matter of Aspects 15-19 includes, the receiving material including a three-dimensional (3D) supporting matrix; wherein the processor is configured to actuate the one or more drives of the gantry translate or rotate the print nozzle toward the specified coordinates corresponding to the 3D supporting matrix.

In Aspect 21, the subject matter of Aspects 15-20 includes, wherein the processor is configured to: receive imaging data corresponding with a position of the print nozzle during depositing of the at least one viscoelastic droplet onto the receiving material; and reprocess the imaging data as feedback in positioning the print nozzle.

In Aspect 22, the subject matter of Aspect 21 includes, one or more optical linear encoders to provide the imaging data to the processor, the one or more optical linear encoders configured to provide the imaging data at a resolution less than 5 nanometers (nm).

In Aspect 23, the subject matter of Aspects 15-22 includes, wherein the specified acceleration is within a range of 0.1 meters per second squared (m/s²) and 25 m/s².

In Aspect 24, the subject matter of Aspect 23 includes, wherein the one or more drives include a servomotor configured to position the print nozzle with an accuracy of less than ±2 μm on at least one plane with respect to the specified coordinates.

In Aspect 25, the subject matter of Aspects 23-24 includes, wherein the one or more drives include a servomotor actuatable for moving the print nozzle at a speed greater than 2.5 meters per second (m/s) and an acceleration greater than 2 g-force (g).

In Aspect 26, the subject matter of Aspects 15-25 includes, wherein the processor is configured to regulate an average flow velocity of a viscoelastic material during depositing of the at least one viscoelastic droplet within a range of 1.0×10⁻³ meters per second (m/s) and 1.2×10⁻³ m/s.

In Aspect 27, the subject matter of Aspects 15-26 includes, wherein the print nozzle includes a linear screw actuator to control an average flow velocity of a viscoelastic material through an aperture of the print nozzle during depositing of the at least one viscoelastic droplet.

In Aspect 28, the subject matter of Aspects 15-27 includes, wherein the processor is configured to actuate the one or more drives of a gantry to detach the print nozzle from the droplet and a receiving material including controlling a shear rate between the print nozzle and the receiving material within a range of 25 s⁻¹ and 35s⁻¹.

In Aspect 29, the subject matter of Aspects 15-28 includes, wherein the print nozzle includes an aperture sized and shaped to deposit the specified diameter of the at least one viscoelastic droplet, the specified diameter within a range of 300 micrometers (μm) and 900 μm.

In Aspect 30, the subject matter of Aspects 15-29 includes, wherein the specified diameter of the at least one viscoelastic droplet has a diameter within a range of 80% and 200% of an aperture diameter of the print nozzle.

Aspect 31 is at least one non-transitory machine-readable medium including instructions for printing viscoelastic ink droplets in an aqueous medium, which when executed by a processor, cause the processor to: position a print nozzle at specified coordinates in the aqueous medium; triggering deposition of viscoelastic material to form at least one viscoelastic droplet including a specified diameter, the deposition established by delivering a specified flow velocity of a viscoelastic material through an aperture in the print nozzle; and detaching the print nozzle from the droplet and a receiving material by translating the print nozzle relative to the droplet according to a specified acceleration; wherein the droplet is captive on or within the receiving material located in the aqueous medium.

In Aspect 32, the subject matter of Aspect 31 includes, wherein the specified coordinates include first coordinates corresponding to a first pixel or a first voxel from an image defining a three-dimensional (3D) structure to be printed; wherein positioning the print nozzle includes establishing or adjusting the position of the print nozzle to compensate for displacement of the at least one viscoelastic droplet away from the specified coordinates in relation to detaching the print nozzle from the droplet.

In Aspect 33, the subject matter of Aspect 32 includes, instructions which cause the processor to facilitate digital assembly of spherical particles (DASP) to establish the three-dimensional (3D) structure including the at least one deposited viscoelastic droplet.

In Aspect 34, the subject matter of Aspect 33 includes, wherein: the at least one viscoelastic droplet includes a bio-ink; and facilitating the DASP includes assembling a plurality of viscoelastic droplets to establish a biological material model.

In Aspect 35, the subject matter of Aspect 34 includes, wherein the biological material model includes 3D mammalian biological material.

In Aspect 36, the subject matter of Aspects 31-35 includes, instructions which cause the processor to translate or rotate the print nozzle toward the specified coordinates; wherein the receiving material includes a three-dimensional (3D) supporting matrix.

In Aspect 37, the subject matter of Aspects 31-36 includes, instructions which cause the processor to: image the depositing of the at least one viscoelastic droplet onto the receiving material; and reprocess the imaging as feedback in positioning the print nozzle.

In Aspect 38, the subject matter of Aspects 31-37 includes, wherein the specified acceleration is within a range of 0.1 meters per second squared (m/s²) and 25 m/s².

In Aspect 39, the subject matter of Aspects 31-38 includes, instructions which cause the processor to establish or adjust the specified acceleration to regulate a roundness of the deposited at least one viscoelastic droplet to length/width ratio within a range from 1:1 to 2.5:1.

In Aspect 40, the subject matter of Aspect 39 includes, instructions which cause the processor to establish or adjust the low shear rate viscosity of the viscoelastic material within a range of 35 pascal-seconds (Pa·s) and 45 Pa·s.

In Aspect 41, the subject matter of Aspects 31-40 includes, instructions which cause the processor to regulate an average flow velocity of a viscoelastic material during depositing of the at least one viscoelastic droplet within a range of 1.0×10−3 meters per second (m/s) and 1.2×10−3 m/s.

In Aspect 42, the subject matter of Aspects 31-41 includes, wherein detaching the print nozzle from the droplet and the receiving material at a specified acceleration includes controlling a shear rate between the print nozzle and the receiving material within a range of 25 s−1 and 35s−1.

In Aspect 43, the subject matter of Aspects 31-42 includes, wherein the specified diameter of the at least one viscoelastic droplet is within a range of 300 micrometers (μm) and 900 μm.

In Aspect 44, the subject matter of Aspects 31-43 includes, wherein the specified diameter of the at least one viscoelastic droplet has a diameter within a range of 80% and 200% of an aperture diameter of the print nozzle.

Aspect 45 is at least one machine-readable medium including instructions that, when executed by processing circuitry, cause the processing circuitry to perform operations to implement of any of Aspects 1-44.

Aspect 46 is an apparatus comprising means to implement of any of Aspects 1-44.

Aspect 47 is a system to implement of any of Aspects 1-44.

Aspect 48 is a method to implement of any of Aspects 1-44.

The above Detailed Description can include references to the accompanying drawings, which form a part of the detailed description. The drawings show, by way of illustration, specific examples in which the invention can be practiced. These examples are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other examples can be used, such as by one of ordinary skill in the art upon reviewing the above description. The Abstract is provided to help allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed example. Thus, the following claims are hereby incorporated into the Detailed Description as examples or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

1. A method for printing viscoelastic aqueous droplets in an aqueous supporting bath, the method comprising:
positioning a print nozzle at a specified coordinates in an aqueous medium;
triggering deposition of viscoelastic material to form at least one viscoelastic droplet comprising a specified diameter, the deposition established by delivering a specified flow velocity of a viscoelastic material through an aperture in the print nozzle; and
detaching the print nozzle from the droplet and a receiving material by translating the print nozzle relative to the droplet according to a specified acceleration;
wherein the droplet is captive on or within the receiving material located in the aqueous medium.

2. The method of claim 1,
wherein the specified coordinates comprise first coordinates corresponding to a first pixel or a first voxel from an image defining a three-dimensional (3D) structure to be printed;
wherein positioning the print nozzle includes establishing or adjusting the position of the print nozzle to compensate for displacement of the at least one viscoelastic droplet away from the specified coordinates in relation to detaching the print nozzle from the droplet.

3. The method of claim 2, comprising performing digital assembly of spherical particles (DASP) to establish the three-dimensional (3D) structure including the at least one deposited viscoelastic droplet.

4. The method of claim 3, wherein:
the at least one viscoelastic droplet includes biological material; and
performing DASP includes assembling a plurality of viscoelastic droplets to establish a biological material model.

5. The method of claim 4, wherein the biological material includes mammalian cells.

6. The method of claim 1, wherein positioning the print nozzle includes at least one of translating or rotating the print nozzle toward the specified coordinates; and
wherein the receiving material comprises a three-dimensional (3D) supporting matrix.

7. The method of claim 1, wherein positioning the print nozzle includes:
imaging the depositing of the at least one viscoelastic droplet onto the receiving material; and
using the imaging as feedback in positioning the print nozzle.

8-15. (canceled)

16. A system for printing viscoelastic ink droplets in an aqueous medium, the system comprising:
a print nozzle configured to be positioned via one or more drives of a gantry toward specified coordinates in the aqueous medium; and
a processor configured to:
trigger depositing viscoelastic material to form at least one viscoelastic droplet comprising a specified diameter, the deposition established by delivering a specified flow velocity of a viscoelastic material through an aperture in the print nozzle; and
actuate the one or more drives of a gantry to detach the print nozzle from the droplet and a receiving material by translating the print nozzle relative to the droplet according to a specified acceleration;
wherein the droplet is captive on or within the receiving material located in the aqueous medium.

17. The system of claim 16,
wherein the specified coordinates comprise first coordinates corresponding to a first pixel or a first voxel from an image defining a three-dimensional (3D) structure to be printed;
wherein the processor is configured to establish or adjust the position of the print nozzle to compensate for displacement of the at least one viscoelastic droplet away from the specified coordinates in relation to detaching the print nozzle from the droplet.

18. The system of claim 17, wherein the processor is configured to facilitate digital assembly of spherical particles (DASP) to establish the three-dimensional (3D) structure including the at least one deposited viscoelastic droplet.

19. The system of claim 18, wherein the print nozzle is fluidly coupled to a reservoir configured to supply a viscoelastic material including bio-ink to the print nozzle; and
wherein the processor is configured to facilitate DASP including assembling a plurality of viscoelastic droplets using, the supplied viscoelastic material, to establish a biological material model.

20. The system of claim 19, wherein the processor is configured to facilitate DASP to assemble 3D mammalian biological material included in biological material model.

21. The system of claim 16, comprising the receiving material including a three-dimensional (3D) supporting matrix;
wherein the processor is configured to actuate the one or more drives of the gantry translate or rotate the print nozzle toward the specified coordinates corresponding to the 3D supporting matrix.

22. The system of claim 16, wherein the processor is configured to:
receive imaging data corresponding with a position of the print nozzle during depositing of the at least one viscoelastic droplet onto the receiving material; and
reprocess the imaging data as feedback in positioning the print nozzle.

23-31. (canceled)

32. At least one non-transitory machine-readable medium including instructions for printing viscoelastic ink droplets in an aqueous medium, which when executed by a processor, cause the processor to:
position a print nozzle at specified coordinates in the aqueous medium;
triggering deposition of viscoelastic material to form at least one viscoelastic droplet comprising a specified diameter, the deposition established by delivering a specified flow velocity of a viscoelastic material through an aperture in the print nozzle; and
detaching the print nozzle from the droplet and a receiving material by translating the print nozzle relative to the droplet according to a specified acceleration;
wherein the droplet is captive on or within the receiving material located in the aqueous medium.

33. The at least one machine-readable medium of claim 32,
wherein the specified coordinates comprise first coordinates corresponding to a first pixel or a first voxel from an image defining a three-dimensional (3D) structure to be printed;
wherein positioning the print nozzle includes establishing or adjusting the position of the print nozzle to compensate for displacement of the at least one viscoelastic droplet away from the specified coordinates in relation to detaching the print nozzle from the droplet.

34. The at least one machine-readable medium of claim 33, including instructions which cause the processor to facilitate digital assembly of spherical particles (DASP) to establish the three-dimensional (3D) structure including the at least one deposited viscoelastic droplet.

35. The at least one machine-readable medium of claim 34, wherein:
the at least one viscoelastic droplet includes a bio-ink; and
facilitating the DASP includes assembling a plurality of viscoelastic droplets to establish a biological material model.

36. (canceled)

37. The at least one machine-readable medium of claim 32, including instructions which cause the processor to translate or rotate the print nozzle toward the specified coordinates;
wherein the receiving material comprises a three-dimensional (3D) supporting matrix.

38. The at least one machine-readable medium of claim 32, including instructions which cause the processor to:
image the depositing of the at least one viscoelastic droplet onto the receiving material; and
reprocess the imaging as feedback in positioning the print nozzle.

39-45. (canceled)
